(19) United States
(12) Patent Application Publication
(10) Pub. No.: US 2024/0356393 A1
(43) Pub. Date: Oct. 24, 2024

(54) ROTOR WITH AN END PLATE WITH A CURVATURE

(71) Applicant: VALEO EAUTOMOTIVE GERMANY GMBH, Erlangen (DE)

(72) Inventors: Christoph WIECZOREK, Bad Neustadt a.d.Saale (DE); Sebastian DIETERICH, Bad Neustadt a.d.Saale (DE); Markus RUBI, Bad Neustadt a.d.Saale (DE); Alexander SCHLERETH, Bad Neustadt a.d.Saale (DE); Kay LEMMERT, Bad Neustadt a.d.Saale (DE); Stephan HELLMUTH, Bad Neustadt a.d.Saale (DE); Robert WERNER, Bad Neustadt a.d.Saale (DE); Robin BUESCH, Bad Neustadt a.d.Saale (DE)

(73) Assignee: VALEO EAUTOMOTIVE GERMANY GMBH, Erlangen (DE)

(21) Appl. No.: 18/574,256

(22) PCT Filed: May 24, 2022
(86) PCT No.: PCT/EP2022/063983

§ 371 Date: Dec. 26, 2023

(30) Foreign Application Priority Data
Jun. 30, 2021 (DE) 10 2021 206 837.5

(51) Int. Cl. H02K 1/27; H02K 15/03; H02K 15/12

(52) U.S. Cl. CPC H02K 1/27; H02K 15/03; H02K 15/12

(57) ABSTRACT

A rotor for an electric machine includes a laminated core formed from stacked electric sheets and having a plurality of magnet pockets, each axially penetrating the laminated core, a plurality of magnets, of which at least one is inserted into each of the magnet pockets. A plurality of free spaces are each delimited by the magnets inserted into one of the magnet pockets and by the laminated core. A first end sheet is arranged on an axial side of the laminated core and a second end sheet arranged on the opposite axial side of the laminated core and has an axially curved portion by which a connecting channel is formed, which connects a first of the free spaces to a second of the free spaces.

The invention relates to a rotor for an electric machine, to an electric machine having a rotor, to a vehicle having an electric machine and to a method for producing the rotor.

Electric machines having a rotor are increasingly used in electrically driven vehicles and hybrid vehicles, predominantly as electric motors for driving a wheel or an axle of such a vehicle.

Such an electric motor is mostly mechanically coupled to a gearbox for rotational speed adaptation. The electric motor is additionally generally electrically coupled to an inverter which, from DC voltage that is provided from a battery, generates AC voltage, for example multi-phase AC voltage, for the operation of the electric motor.

It is also possible to operate an electric machine having such a rotor as a generator for recovering kinetic energy of a vehicle. For this purpose, the kinetic energy is first converted into electrical energy and then into chemical energy of a vehicle battery.

The rotor may have a laminated core (rotor core) in which a plurality of magnet pockets are arranged, in which magnets (permanent magnets) are located in each case. It must be ensured that the magnets maintain their position in the magnet pockets, in particular at high rotational speeds. For this purpose, it is customary to pot the magnets in the magnet pockets with a potting compound so that the magnets are reliably secured in the laminated core.

During the potting operation, the potting compound may flow through the laminated core in an axial direction through a first free space, be deflected and then flow through the laminated core in an opposite axial direction through a second free space. To deflect the potting compound, an end plate arranged on an axial side of the laminated core is required, in which a connecting channel is formed which connects the first free space to the second free space. However, the provision of the end plate with the connecting channel results in greater material outlay and assembly effort and therefore increased costs.

The object of the invention consists in providing a rotor having a laminated core and magnets potted therein, which can be produced in a particularly cost-effective manner.

The object is achieved by a rotor according to the invention, which has the following component parts:
a laminated core formed from stacked electric sheets and having a plurality of magnet pockets, each axially penetrating the laminated core,
a plurality of magnets, of which at least one is inserted into each of the magnet pockets,
a plurality of free spaces, which are each delimited by the magnets inserted into one of the magnet pockets and by the laminated core,
a first end sheet arranged on an axial side of the laminated core and
a second end sheet arranged on the opposite axial side of the laminated core and having an axially curved portion by which a connecting channel is formed, which connects a first of the free spaces to a second of the free spaces.

The free spaces may be sealed with a potting compound, whereby the magnets are fixed in the laminated core, in particular adhesively bonded to the laminated core. The potting operation represents a comparatively simple and cost-effective way of securing the magnets.

By forming the connecting channel by the curved portion of the second end sheet, it is possible to dispense with an end plate for forming the connecting channel. This reduces material outlay and assembly effort, whereby the rotor can be produced in a particularly cost-effective manner.

In particular, the curved portion may be generated in a simple manner by deep-drawing the second end sheet. However, the curved portion may also be produced in a different way. The curved portion may furthermore have, inter alia, a rectangular, oval or circular outline.

The laminated core may be formed from the electric sheets, in that these are welded, adhesively bonded, punch-stacked or secured to one another in a different way. In particular, the laminated core may have a cylindrical shape. Furthermore, each electric sheet may have a central opening, which openings, in the mounted state, form an axial bore of the laminated core, through which a rotor shaft of the rotor may lead. The axis of the rotor shaft or of the rotor corresponds to the axial axis of the laminated core.

The first end sheet and/or the second end sheet may comprise a different material to that of the electric sheets, in particular a non-magnetic material. A non-magnetic high-grade steel may preferably be considered for this. Furthermore, the end sheets may each have a central opening, through which the rotor shaft of the rotor may lead.

Apart from the rotor, the electric machine may have a stator, relative to which the rotor can rotate. The stator may have a further laminated core (stator core), which is formed from stacked electric sheets. In addition, the stator may have windings of electrical conductors, for example as coil windings or flat wire windings.

The magnet pockets may be distributed along the circumference of the laminated core, for example at identical spacings from each other. The magnet pockets, and the magnets arranged therein, may optionally be mutually different sizes. The magnets arranged in one of the magnet pockets are lined up axially, for example. Thus, during mounting of the rotor, the magnets may be simply inserted or pushed into the magnet pocket one after the other.

The axially lined-up magnets are referred to as a “magnet stack”. The rotor may have a plurality of such magnet stacks, which are each arranged in a magnet pocket. Alternatively, instead of a plurality of magnets, it is possible to arrange only one magnet in one or more magnet pockets in each case.

In an embodiment of the invention, the first end sheet has a filling opening, by which the first free space is exposed, and a venting opening, by which the second free space is exposed. It is thus possible to fill the laminated core with the potting compound after the first end sheet has been arranged on the laminated core.

In this case, the first free space may be formed on a lateral surface of one of the magnet pockets and the second free space may be formed on an opposite lateral surface of the magnet pocket. The magnets arranged between the two free spaces can thus be secured particularly well during the potting operation.

In a further embodiment of the invention, the connecting channel extends between a magnet, which is inserted into the magnet pocket and arranged on the end sheet, and the end sheet. Thus, the connecting channel is comparatively short and space-saving.

In a further embodiment of the invention, the curved portion projects inwards and the magnet lies against the curved portion. This means that the curved portion projects axially into the laminated core, so that the magnet is spaced from the plane of the second end sheet. In particular, the curved portion may be designed to be somewhat narrower than the magnet. The connecting channel may thus extend between the magnet and the end sheet on one side or on both sides of the curved portion.

In a further embodiment of the invention, the curved portion projects outwards and the magnet lies against the edge of the curved portion. This means that the curved portion projects axially out of the laminated core, so that the magnet is arranged on the plane of the second end sheet. The connecting channel may thus extend between the magnet and the end sheet due to the curved portion. The edge is located at the point where the curved portion transitions into the planar region of the end sheet.

In this case, the curved portion may be designed to be somewhat longer than the magnet in the longitudinal direction of the connecting channel, so that the curved portion projects beyond the magnet on two opposing sides. Thus, the first free space and the second free space may each lead into the connecting channel next to the magnet.

In particular, the magnet may lie against two mutually opposing sides of the edge. Thus, the connecting channel may extend parallel to the opposing sides. In addition, the curved portion may be designed to be somewhat narrower than the magnet transversely to the connecting channel, so that the magnet projects beyond the curved portion on two opposing sides.

In a further alternative, the magnet may lie with only one corner, with only two of its corners or with only three of its corners against the edge. There are therefore further options for the progression of the connecting channel between the magnet and the end sheet.

In a further embodiment of the invention, the magnets are potted with a potting compound introduced into the free spaces. Normally, the free spaces are completely filled with potting compound However, it is also possible to only partially fill the free spaces with potting compound. The potting compound used may be, inter alia, an epoxy resin, a mixture of an epoxy resin and a curing agent, or an adhesive.

In a further embodiment of the invention, the laminated core has a plurality of laminated core segments.

In this case, one of the laminated core segments may be twisted in the circumferential direction relative to another of the laminated core segments. The rotational behaviour of the rotor may thus be improved.

The object is furthermore achieved by an electric machine which has a rotor according to the invention. In addition, the electric machine may have a stator, relative to which the rotor can rotate. The stator may have a further laminated core, which is formed from stacked electric sheets. In addition, the stator may have windings of electrical conductors, for example as coil windings or flat wire windings. The machine may be optionally equipped with a housing, in which the rotor and the stator are received, wherein the rotor shaft may project from the housing.

Furthermore, the object is achieved by a vehicle having such an electric machine, which is provided for driving the vehicle. The machine may, in particular, drive a wheel or an axle of the vehicle.

The object is furthermore achieved by a method for producing a rotor according to the invention. The method comprises the following method steps:
forming a laminated core having a plurality of magnet pockets, each axially penetrating the laminated core, from stacked electric sheets,
inserting at least one magnet into each of the magnet pockets, wherein a plurality of free spaces remain, which are each delimited by the magnets inserted into one of the magnet pockets and by the laminated core,
arranging a first end sheet on an axial side of the laminated core,
arranging a second end sheet having an axially curved portion on the opposite axial side of the laminated core, which axially curved portion forms a connecting channel which connects a first of the the free spaces to a second of the free spaces, and
potting the magnets with a potting compound, which is introduced into the free spaces.

The invention will be discussed below on the basis of an exemplary embodiment with reference to the figures. The figures are schematic illustrations in which:

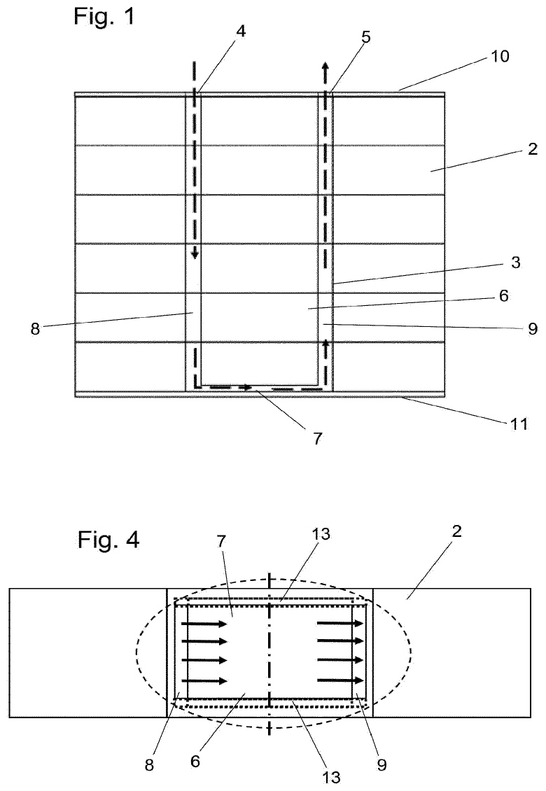

FIG. 1 shows a sectional view of a region of a rotor according to the invention,

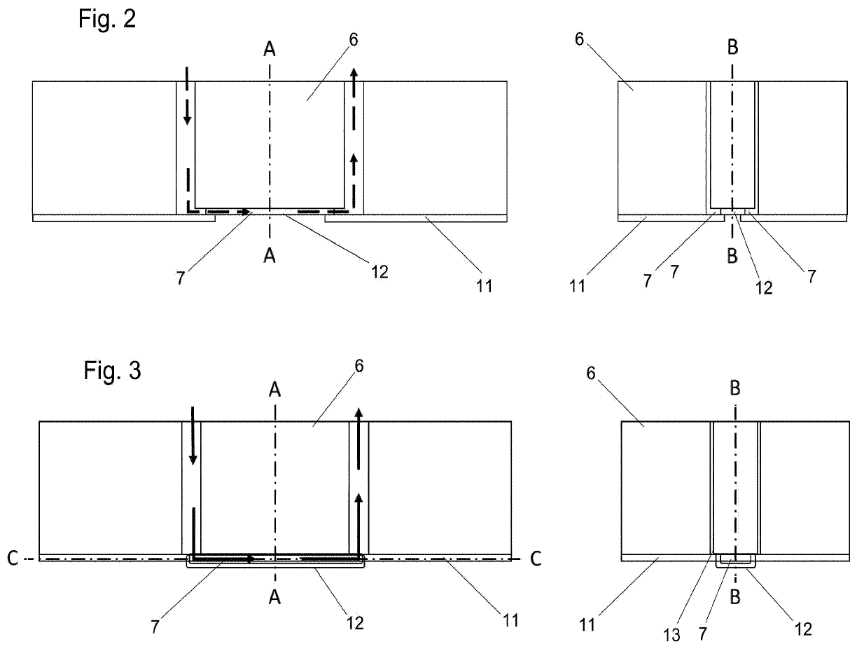

FIG. 2 shows a sectional view of a region of a first embodiment of the rotor,

FIG. 3 shows a sectional view of a region of a second embodiment of the rotor,

FIG. 4 shows an axial view of a region of the second embodiment of the rotor,

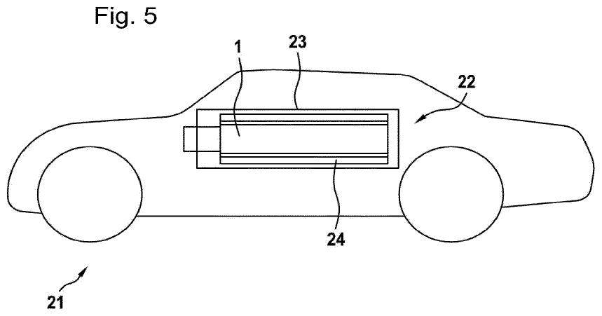

FIG. 5 shows a vehicle having an electric machine with the rotor.

FIG. 1 shows a sectional view of a region of a rotor according to the invention. The rotor belongs to an electric machine, which is provided for driving a vehicle.

The rotor has a laminated core 2 formed from stacked electric sheets, which is formed from six axially lined-up laminated core segments. However, it is also possible to dispense with the segmentation of the laminated core. A plurality of magnet pockets 3 are located in the laminated core 2, each axially penetrating the laminated core 2 and of which one is shown. Six magnets 6 are lined up axially in the magnet pocket 3 so as to form a magnet stack 6.

A first free space 8 and a second free space 9, which are each delimited by the magnet stack 6 and the laminated core 2, are additionally located in the magnet pocket 3. The first free space 8 is formed on a lateral surface of the magnet pocket 3, and the second free space 9 is formed on an opposite lateral surface of the magnet pocket 3.

A first end sheet 10, which has a filling opening 4 and a venting opening 5, is arranged on the upper axial side of the laminated core 2. The first free space 8 is exposed by the filling opening 4 and the second free space 9 is exposed by the venting opening 5.

Furthermore, a second end sheet 11 is arranged at the lower axial side of the laminated core 2, along which end sheet a connecting channel 7 extends, which connects the first free space 8 to the second free space 9. The connecting channel 7 is formed by an axially curved portion (not shown in FIG. 1) of the laminated core 2 and extends between the bottom magnet 6 and the second end sheet 11.

FIG. 2 shows a sectional view of a region of a first embodiment of the rotor. The region is shown from a first perspective on the left and from a second perspective, rotated through 90 degrees, on the right.

In this embodiment of the invention, the curved portion 12 projects axially inwards and the bottom magnet 6 lies against the curved portion 12. This means that the curved portion 12 projects into the laminated core 2, so that the magnet 6 is spaced from the plane of the second end sheet 11.

Moreover, the curved portion 12 is designed to be somewhat narrower than the magnet 6, so that the magnet 6 projects beyond the curved portion 12 on two opposing sides. The connecting channel 7 may thus extend between the magnet 6 and the end sheet 12 on both sides of the curved portion 12.

FIG. 3 shows a sectional view of a region of a second embodiment of the rotor. The region is shown from a first perspective on the left and from a second perspective, rotated through 90 degrees, on the right.

In this embodiment of the invention, the curved portion 12 projects axially outwards and the bottom magnet 6 lies against the edge 13 of the curved portion 12. This means that the curved portion 12 projects out of the laminated core 2, so that the magnet 6 is arranged on the plane of the second end sheet 11. The connecting channel 7 may thus extend between the magnet 6 and the end sheet 11 due to the curved portion 12.

In particular, the curved portion is designed to be somewhat longer than the magnet 6 in the longitudinal direction of the connecting channel, so that the curved portion 12 projects beyond the magnet 6 on two opposing sides. The first free space 8 and the second free space 9 may thus each lead into the connecting channel 7 next to the magnet 6.

The edge 13 is located at the point where the curved portion 12 transitions into the planar region of the end sheet 11. In particular, the magnet lies against two opposing sides of the edge 13, so that the connecting channel 7 extends parallel to these sides. In addition, the curved portion 12 is designed to be somewhat wider than the magnet 6 transversely to the connecting channel 7, so that the magnet 6 projects beyond the curved portion on two opposing sides.

FIG. 4 shows an axial view of a region of the second laminated core 2 from below according to the second embodiment of the rotor. The second end sheet 11 is not shown so as to enable a view of the connecting channel 7. In FIG. 4, it can be seen particularly clearly that the magnet 6 lies against two opposing sides of the edge 13, wherein the connecting channel 7 extends parallel to these sides and the free spaces 8, 9 lead into the connecting channel 7.

FIG. 5 shows a vehicle 21 having an electric machine 22 which serves for driving the vehicle 21. The machine 22 has a housing 23 in which are received the rotor 1 according to the invention and a stator 24 which surrounds the rotor 1.

A method for producing the rotor according to the invention is described below with reference to the figures. In the method, the following steps are carried out:

In a first method step, the laminated core 2 having a plurality of magnet pockets 3, each axially penetrating the laminated core 2, is formed from stacked electric sheets.

In a second method step, a plurality of magnets 6 are inserted into each magnet pocket 3. In particular, the magnets 6 are lined up axially so as to form a magnet stack. Remaining next to each magnet stack are two free spaces 8, 9, which are each delimited by the magnet stack and the laminated core 2.

In a third method step, the first end sheet 10 is arranged on an axial side of the laminated core 2. The first end sheet 10 has filling openings 4 and venting openings 5, by which one of the free spaces 8, 9 is exposed in each case.

In a fourth method step, the second end sheet 11 is arranged on the opposite axial side of the laminated core 2. The second end sheet 11 has axially curved portions 12, by which a connecting channel 7 is formed in each case, which connects a first of the free spaces 8 to a second of the free spaces 9. The curved portions 12 may have been generated by deep-drawing the second end sheet 11. The rotor 1 completed in this way is oriented vertically, with the first end sheet 10 to the top.

In a fifth method step, the magnets 6 are potted with a potting compound, which is introduced into the free spaces 8, 9. For this purpose, a nozzle of a metering device is placed on each filling opening 4. The potting compound is then pressed into the associated free space 8 under positive pressure in each case using the nozzle. The magnets 6 are thus potted in the associated magnet pocket 3.

Specifically, the potting compound firstly flows axially downwards through the first free space 8 as far as the second end sheet 11. The potting compound then flows through the connecting channel 7 to the second free space 9. The potting compound then flows axially upwards through the second free space 9 as far as the first end sheet 10. Here, air which is present in the magnet pocket 3 can escape through the venting opening 5 and be replaced by the potting compound.

The flow direction of the potting compound or air is illustrated by dashed arrows in the figures.

The potting compound is cured after the potting operation. In addition, the rotor shaft 4 may be guided through an axially extending central through-opening in the laminated core 2 (and corresponding openings in the end sheets 10, 11) such that the laminated core 2 encloses the rotor shaft 4 or is secured thereto.

### LIST OF REFERENCE SIGNS

2 Laminated core
3 Magnet pocket
4 Filling opening
5 Venting opening
6 Magnet
7 Connecting channel
8 Free space
9 Free space
10 End sheet
11 End sheet
12 Curved portion
13 Edge
21 Vehicle
22 Electric machine
23 Housing
24 Stator

1. A rotor for an electric machine, having:
a laminated core formed from stacked electric sheets and having a plurality of magnet pockets, each axially penetrating the laminated core,
a plurality of magnets, of which at least one is inserted into each of the magnet pockets,
a plurality of free spaces, which are each delimited by the magnets inserted into one of the magnet pockets and by the laminated core ,
a first end sheet arranged on an axial side of the laminated core and
a second end sheet arranged on the opposite axial side of the laminated core and having an axially curved portion by which a connecting channel is formed, which connects a first of the free spaces to a second of the free spaces.

2. The rotor as claimed in claim 1, wherein the first end sheet has a filling opening, by which the first free space is exposed, and a venting opening, by which the second free space is exposed.

3. The rotor as claimed in claim 1, wherein the first free space is formed on a lateral surface of one of the magnet pockets, and the second free space is formed on an opposite lateral surface of the magnet pocket.

4. The rotor as claimed in claim 3, wherein the connecting channel extends between a magnet, which is inserted into the magnet pocket and arranged on the second end sheet, and the second end sheet.

5. The rotor as claimed in claim 4, wherein the curved portion projects inwards and the magnet lies against the curved portion.

6. The rotor as claimed in claim 4, wherein the curved portion projects outwards and the magnet lies against the edge of the curved portion.

7. The rotor as claimed in claim 6, wherein the magnet lies against two mutually opposing sides of the edge.

8. The rotor as claimed in claim 6, wherein the magnet lies with only one corner, with only two corners or with only three corners against the edge.

9. The rotor as claimed in claim 1, wherein the magnets are potted with a potting compound introduced into the free spaces.

10. The rotor as claimed in claim 1, wherein the laminated core has a plurality of laminated core segments.

11. The rotor as claimed in claim 10, wherein one of the laminated core segments is twisted in the circumferential direction relative to another of the laminated core segments.

12. An electric machine having a rotor as claimed in claim 1.

13. A vehicle having an electric machine as claimed in claim 12, which is provided for driving the vehicle.

14. A method for producing a rotor for an electric machine, comprising the following steps:
forming a laminated core having a plurality of magnet pockets, each axially penetrating the laminated core, from stacked electric sheets,
inserting at least one magnet into each of the magnet pockets, wherein a plurality of free spaces remain, which are each delimited by the magnets inserted into one of the magnet pockets and by the laminated core,
arranging a first end sheet on an axial side of the laminated core,
arranging a second end sheet having an axially curved portion on the opposite axial side of the laminated core, which axially curved portion forms a connecting channel which connects a first of the free spaces to a second of the free spaces, and
potting the magnets with a potting compound, which is introduced into the free spaces.

15. The method as claimed in claim 14, wherein, during the potting operation, the potting compound flows from the first free space into the second free space through the connecting channel.

16. The rotor as claimed in claim 2, wherein the first free space is formed on a lateral surface of one of the magnet pockets, and the second free space is formed on an opposite lateral surface of the magnet pocket.

17. The rotor as claimed in claim 2, wherein the magnets are potted with a potting compound introduced into the free spaces.

18. The rotor as claimed in claim 2, wherein the laminated core has a plurality of laminated core segments.

19. An electric machine having a rotor as claimed in claim 2.

20. The rotor as claimed in claim 3, wherein the magnets are potted with a potting compound introduced into the free spaces.
